(19) United States
(12) Patent Application Publication
(10) Pub. No.: US 2007/0003156 A1
(43) Pub. Date: Jan. 4, 2007

(54) Image enhancing system

(75) Inventors: Ping-Heng Lin, Taiepi (TW); Hao-Chun Chung, Taipei (TW)

Correspondence Address: BIRCH STEWART KOLASCH & BIRCH, PO BOX 747, FALLS CHURCH, VA, 22040-0747, US

(73) Assignee: Ali Corporation

(21) Appl. No.: 11/477,944

(22) Filed: Jun. 30, 2006

(30) Foreign Application Priority Data
Jul. 1, 2005 (TW) 94122451

(51) Int. Cl. G06K 9/40

(52) U.S. Cl. 382/260

(57) ABSTRACT

An image enhancing system uses a multi-resolution filter to analyze the image and process noise from the image and the details of the high frequency image. The image enhancing system uses a wavelet transform structure to decompose and process the image. The image enhancing system does not need to down sample and it directly changes the frequency of the processing unit. The low-frequency image is processed by a brightness adjusting process, such as a Gamma (γ) transfer function, to enhance the details of the image. The high-frequency image is processed by a threshold unit to eliminate noise and reserve the original details of the image. Next, the image enhancing system uses an amplifying unit to amplify the image and reconstructs the image with full resolution.

### BACKGROUND OF THE INVENTION

1. Field of the Invention

The present invention relates to an image enhancing system. In particular, an apparatus that uses a multi-resolution filter to analyze the image and processes noise from the image and the details of the high frequency image.

2. Description of the Related Art

Because video products have become extremely popular lately, people can enjoy beautiful images along with excellent sound quality. The quality of the image is an important factor for the image product. The sensing system for obtaining the image and the display system for displaying the image decides the quality of the image. Both systems need an image processing system to make the image clearer and vivid.

The most commonly used method is to use a variety of filters to process an image. For example, a low pass filter is used for eliminating image noise and a high pass filter is used for enhancing the details of the image. Thereby the user can view a better image.

FIG. 1 shows a flow chart of the image processing method of the prior art. Firstly, a low pass filter 10 is used for eliminating noise of the image. Secondly, a high pass filter 12 processes the image processed by the low pass filter 10. Thirdly, a gain control unit 14 is used for enhancing the details of the image. Finally, an adder 16 is used for adding the signals processed by the low pass filter 10 and the signals processed by gain control unit 14 to obtain a final image with good quality. The low pass filter can be a GAUSS filter or a mean-value filter. The high pass filter is an edge-detection filter, such as a Sobel filter. The conventional image processing method needs to compromise between enhancing the details of the image and eliminating noise from the image. For example, if noise from the image is eliminated clearly, the high pass filter cannot recover the details of the image. If noise from the image is not adequately eliminated, the high pass filter amplifies noise and the quality of the recovered image is affected.

### SUMMARY OF THE INVENTION

One particular aspect of the present invention is to provide an image enhancing system. The image enhancing system eliminates noise from the image and enhances the details of the image. The image enhancing system uses a multi-resolution filter to analyze the image. The image enhancing system decomposes the image according to different resolution and processes them. Then, the image enhancing system reconstructs the image for each resolution image to obtain an enhanced image.

The image enhancing system includes a first resolution high-pass filter, a first resolution low-pass filter, a first resolution threshold, a first resolution amplifying unit, a brightness-adjusting unit, a first adder and a first normalizing unit. The first resolution high-pass filter chooses the high frequency components of the image to obtain a first resolution high frequency image. The first resolution low-pass filter picks the low frequency components of the image to obtain a first resolution low frequency image. The first resolution threshold connects with the first resolution high-pass filter for processing noise from the first resolution high frequency image. The first resolution amplifying unit connects with the first resolution threshold for enhancing the details of the first resolution high frequency image. The brightness-adjusting unit connects with the first resolution low-pass filter for adjusting the brightness of the first resolution low frequency image. The first adder connects with the first resolution amplifying unit and the brightness-adjusting unit for adding the first resolution high frequency image with the first resolution low frequency image. The first normalizing unit connects with the first adder for normalizing the image to obtain the enhanced image.

The image enhancing system further includes a second resolution high-pass filter, a second resolution low-pass filter, a second resolution threshold, a second resolution amplifying unit, a second adder, and a second normalizing unit. The second resolution high-pass filter picks the high frequency components of the first resolution low frequency image to obtain a second resolution high frequency image. The second resolution low-pass filter picks the low frequency components of the first resolution low frequency image to obtain a second resolution low frequency image. The second resolution threshold connects with the second resolution high-pass filter for processing noise from the second resolution high frequency image. The second resolution amplifying unit connects with the second resolution threshold for enhancing the details of the second resolution high frequency image. The second adder connects with the second resolution amplifying unit and the brightness-adjusting unit for adding the second resolution high frequency image and the second resolution low frequency image. The second normalizing unit connects with the second adder for normalizing the image to obtain a second resolution enhanced image.

In this embodiment, the brightness-adjusting unit connects with the second resolution low-pass filter for adjusting the brightness of the second resolution low frequency image. The first adder connects with the first resolution amplifying unit and the brightness-adjusting unit for adding the first resolution high frequency image and the second resolution enhanced image. The first normalizing unit connects with the first adder for normalizing the output of the first adder to obtain the enhanced image.

The enhancing system of the present invention can be a single-resolution structure, a two-resolution structure or a multi-resolution structure. The multi-resolution structure adopts a two-resolution structure and inputs the low-frequency components of the image into the next resolution to obtain a next resolution image. After processing the image with a multi-resolution structure, noise is eliminated and the details of the image are enhanced. Therefore, the enhanced image is more vivid and more suitable for people to enjoy.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the image-processing system of the prior art;

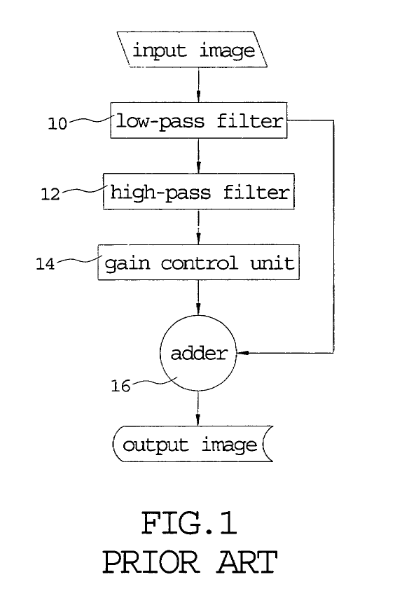

FIG. 2 is a schematic diagram of the image enhancing system with a single-resolution structure of the present invention;

FIG. 3 is a schematic diagram of the image enhancing system with a two-resolution structure of the present invention; and

FIG. 4 is a schematic diagram of the image enhancing system with a multi-resolution structure of the present invention.

### DETAILED DESCRIPTION OF THE PREFERRED EMBODIMENTS

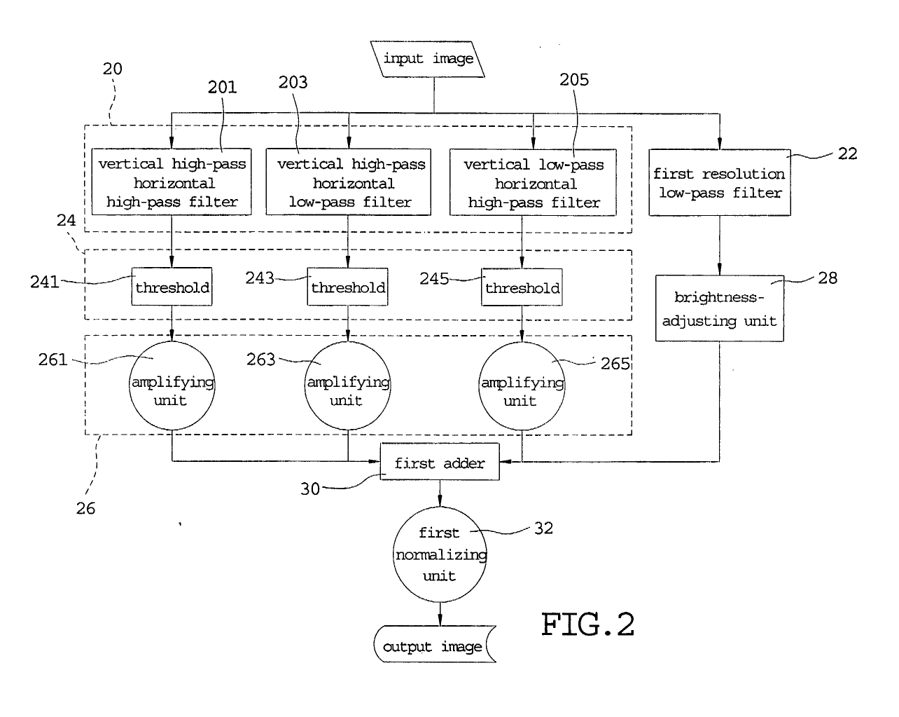

FIG. 2 shows a schematic diagram of the image enhancing system with a single-resolution structure of the present invention. The image enhancing system of the present invention uses a wavelet transform structure to decompose and process the image. The structure of the image enhancing system is similar to the wavelet transform structure. However, the wavelet transform will down sample after each transformation is completed and it utilizes the characteristic of each resolution to decompose the high-frequency components of the image and enhance the details of the image. The image enhancing system of the present invention does not need to down sample and it directly changes the frequency of the processing unit. The loading of the calculation for each resolution is 4 times that of the wavelet transform. Low-frequency images are processed by a brightness adjusting process, such as a Gamma (γ) transfer function, to enhance the details of the image. High-frequency images are processed by a threshold unit to eliminate noise and reserve the original details of the image. Next, the image enhancing system uses an amplifying unit to amplify the image and reconstruct the image with full resolution.

The image reconstructed by the present invention is an over complete reconstruct image. The data of the reconstructed image is 4 times that of the original image. As such, distortion is reduced even though the high frequency image needs to be processed.

The image enhancing system with a single-resolution structure of the present invention includes a first resolution high-pass filter 20, a first resolution low-pass filter 22, a first resolution threshold 24, a first resolution amplifying unit 26, a brightness-adjusting unit 28, a first adder 30, and a first normalizing unit 32.

The first resolution high-pass filter 20 picks the high frequency components of the image to obtain a first resolution high frequency image. The first resolution high-pass filter 20 includes at least one filter. The first resolution high-pass filter 20 includes a vertical high-pass horizontal high-pass filter 201, a vertical high-pass horizontal low-pass filter 203, and a vertical low-pass horizontal high-pass filter 205. The vertical high-pass horizontal high-pass filter 201 processes the vertical image and the horizontal image with a high-pass filter. The vertical high-pass horizontal low-pass filter 203 processes one diagonal image with a high-pass filter and processes another diagonal image with a low-pass filter. The vertical low-pass horizontal high-pass filter 205 processes one diagonal image with a low-pass filter and processes another diagonal image with a high-pass filter. The first resolution high-pass filter 20 can be any type of filter and depends on the specifications of the image.

The first resolution low-pass filter 22 picks the low frequency component of the image to obtain a first resolution low frequency image. The first resolution low-pass filter 22 is a vertical low-pass horizontal low-pass filter for processing vertical images and horizontal images with a low-pass filter. The frequency of the first resolution high-pass filter 20 and the first resolution low-pass filter 22 is set depending upon the specifications of the image.

The first resolution threshold 24 connects with the first resolution high-pass filter 20 for processing noise of the first resolution high frequency image. The number of the first resolution thresholds 24 is the same as the number of the first resolution high-pass filters 20, such as the thresholds 241, 243 and 245 shown in FIG. 2. The first resolution amplifying unit 26 connects with the first resolution threshold 24 for enhancing the details of the first resolution high frequency image. The number of the first resolution amplifying units 26 is the same as the number of the first resolution high-pass filters 20, such as the amplifing units 261, 263 and 265 shown in FIG. 2. The first resolution amplifying unit 26 is an amplifier or a y transfer function.

The brightness-adjusting unit 28 connects with the first resolution low-pass filter 22 for adjusting the brightness of the first resolution low frequency image. The first adder 30 connects with the first resolution amplifying unit 26 and the brightness-adjusting unit 28 for adding the first resolution high frequency image and the first resolution low frequency image. The first normalizing unit 32 connects with the first adder 30 for normalizing the image to obtain an enhanced image.

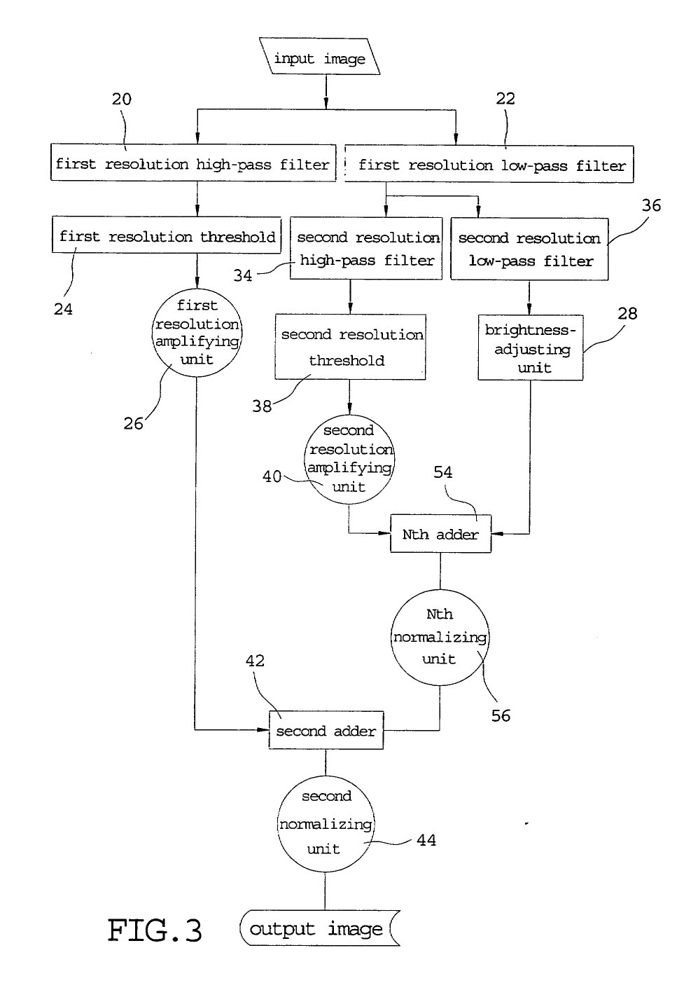

FIG. 3 shows a schematic diagram of the image enhancing system with a two-resolution structure of the present invention. The image enhancing system with a single-resolution structure of the present invention includes a first resolution high-pass filter 20, a first resolution low-pass filter 22, a first resolution threshold 24, a first resolution amplifying unit 26, a second resolution high-pass filter 34, a second resolution low-pass filter 36, a second resolution threshold 28, a second resolution amplifying unit 40, a brightness-adjusting unit 28, a second adder 42, a second normalizing unit 44, a first adder 30, and a first normalizing unit 32.

The first resolution high-pass filter 20 picks the high frequency components of the image to obtain a first resolution high frequency image. The first resolution high-pass filter 20 includes at least one filter. The first resolution high-pass filter 20 includes a vertical high-pass horizontal high-pass filter 201, a vertical high-pass horizontal low-pass filter, 203 and a vertical low-pass horizontal high-pass filter 205. The vertical high-pass horizontal high-pass filter 201 processes the vertical image and the horizontal image with a high-pass filter. The vertical high-pass horizontal low-pass filter 203 processes one diagonal image with a high-pass filter and processes another diagonal image with a low-pass filter. The vertical low-pass horizontal high-pass filter 205 processes one diagonal image with a low-pass filter and processes another diagonal image with a high-pass filter. The type of the first resolution high-pass filter 20 can be any type of filter and depends on the specifications of the image.

The first resolution low-pass filter 22 picks the low frequency components of the image to obtain a first resolution low frequency image. The first resolution low-pass filter 22 is a vertical low-pass horizontal low-pass filter for processing the vertical image and the horizontal image with a low-pass filter. The frequency of the first resolution high-pass filter 20 and the first resolution low-pass filter 22 are set depending on the specifications of the image.

The first resolution threshold 24 connects with the first resolution high-pass filter 20 for processing noise of the first resolution high frequency image. The number of the first resolution thresholds 24 is the same as the number of the first resolution high-pass filters 20, such as the thresholds 241, 243 and 245 shown in FIG. 2. The first resolution amplifying unit 26 connects with the first resolution threshold 24 for enhancing the details of the first resolution high frequency image. The number of the first resolution amplifing units 26 is the same as the number of the first resolution high-pass filters 20, such as the amplifying units 261, 263 and 265 shown in FIG. 2. The first resolution amplifying unit 26 is an amplifier or a γ transfer function.

The second resolution high-pass filter 34 connects with the first resolution low-pass filter 22 for picking the high frequency components of the first resolution low frequency image to obtain a second resolution high frequency image. The second resolution high-pass filter 34 includes at least one filter. The second resolution high-pass filter 34 also includes a vertical high-pass horizontal high-pass filter 201, a vertical high-pass horizontal low-pass filter 203, and a vertical low-pass horizontal high-pass filter 205. The vertical high-pass horizontal high-pass filter 201 processes the vertical image and the horizontal image with a high-pass filter. The vertical high-pass horizontal low-pass filter 203 processes one diagonal image with a high-pass filter and processes another diagonal image with a low-pass filter. The vertical low-pass horizontal high-pass filter 205 processes one diagonal image with a low-pass filter and processes another diagonal image with a high-pass filter. The type of the second resolution high-pass filter 34 can be any type of filter and depends on the specifications of the image.

The second resolution low-pass filter 36 connects with the first resolution low-pass filter 22 for picking the low frequency components of the first resolution low frequency image to obtain a second resolution low frequency image. The second resolution low-pass filter 36 is a vertical low-pass horizontal low-pass filter for processing the vertical image and the horizontal image with a low-pass filter. The frequency of the second resolution high-pass filter 34 and the second resolution low-pass filter 36 is set depending on the specifications of the image.

The second resolution threshold 38 connects with the second resolution high-pass filter 34 for processing noise of the second resolution high frequency image. The number of the second resolution thresholds 38 is the same as the number of the second resolution high-pass filters 34. The second resolution amplifying unit 40 connects with the second resolution threshold 38 for enhancing the details of the first resolution high frequency image. The number of the second resolution amplifying units 40 is the same as the number of the second resolution high-pass filters 40. The second resolution amplifying unit 38 is an amplifier or a γ transfer function.

The brightness-adjusting unit 28 connects with the second resolution low-pass filter 36 for adjusting the brightness of the second resolution low frequency image.

The second adder 42 connects with the second resolution amplifying unit 40 and the brightness-adjusting unit 28 for adding the second resolution high frequency image and the second resolution low frequency image. The second normalizing unit 44 connects with the second adder 42 for normalizing the second resolution image.

The first adder 30 connects with the first resolution amplifying unit 26 and the second normalizing unit 44 for adding the first resolution high frequency image and the second resolution image. The first normalizing unit 32 connects with the first adder 30 for normalizing the image to obtain the enhanced image.

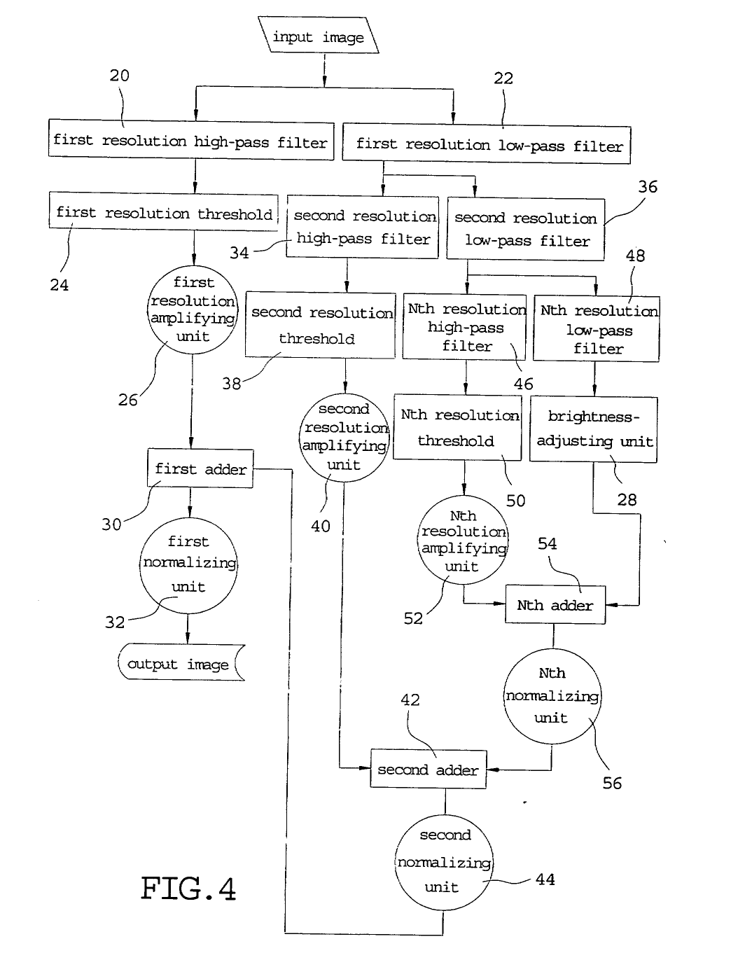

The enhancing system of the present invention can have a single-resolution structure, a two-resolution structure or a multi-resolution structure. The multi-resolution structure adopts the two-resolution structure (shown in FIG. 3) and inputs the low-frequency component of the image into the next resolution to obtain the next resolution image. FIG. 4 shows a schematic diagram of the image enhancing system with a multi-resolution structure of the present invention. The image enhancing system with a multi-resolution structure further includes a Nth resolution high-pass filter 46, a Nth resolution low-pass filter 48, a Nth resolution threshold 50, a Nth resolution amplifying unit 52, a Nth adder 54 and a Nth normalizing unit 56. After processing the image with a multi-resolution structure, noise is eliminated and the details of the image are enhanced. As such, the enhanced image is more vivid and is more suitable for people to enjoy viewing.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An image enhancing system, comprising:
a first resolution high-pass filter, for picking the high frequency components of an image to obtain a first resolution high frequency image;
a first resolution low-pass filter, for picking the low frequency components of the image to obtain a first resolution low frequency image;
a first resolution threshold, connected with the first resolution high-pass filter, for processing noise of the first resolution high frequency image;
a first resolution amplifying unit, connected with the first resolution threshold for enhancing the details of the first resolution high frequency image;
a brightness-adjusting unit, connected with the first resolution low-pass filter, for adjusting the brightness of the first resolution low frequency image;
a first adder, connected with the first resolution amplifying unit and the brightness-adjusting unit, for adding the first resolution high frequency image and the first resolution low frequency image; and
a first normalizing unit, connected with the first adder, for normalizing the image to obtain an enhanced image.

2. The image enhancing system as claimed in claim 1, further comprising:
a second resolution high-pass filter, connected with the first resolution low-pass filter, for picking the high frequency components of the first resolution low frequency image to obtain a second resolution high frequency image;
a second resolution low-pass filter, connected with the first resolution low-pass filter, for picking the low frequency components of the first resolution low frequency image to obtain a second resolution low frequency image;
a second resolution threshold, connected with the second resolution high-pass filter, for processing noise of the second resolution high frequency image;
a second resolution amplifying unit, connected with the second resolution threshold, for enhancing the details of the second resolution high frequency image;
a second adder, connected with the second resolution amplifying unit and the brightness-adjusting unit, for adding the second resolution high frequency image and the second resolution low frequency image; and
a second normalizing unit, connected with the second adder, for normalizing the result of the second adder to obtain a second resolution enhanced image;
wherein the brightness-adjusting unit connects with the second resolution low-pass filter for adjusting the brightness of the second resolution low frequency image, the first adder connects with the first resolution amplifying unit and the brightness-adjusting unit for adding the first resolution high frequency image and the second resolution enhanced image, and the first normalizing unit connects with the first adder for normalizing the output of the first adder to obtain the enhanced image.

3. The image enhancing system as claimed in claim 2, wherein the number of resolutions is two or more than two.

4. The image enhancing system as claimed in claim 2, wherein the second resolution high-pass filter comprises one filter or more than one filter.

5. The image enhancing system as claimed in claim 2, wherein the number of the second resolution thresholds is the same as the second resolution high-pass filters.

6. The image enhancing system as claimed in claim 2, wherein the number of the second resolution amplifying units is the same as the second resolution high-pass filters.

7. The image enhancing system as claimed in claim 2, wherein the second resolution high-pass filter further comprises a vertical high-pass horizontal high-pass filter, a vertical high-pass horizontal low-pass filter, and a vertical low-pass horizontal high-pass filter.

8. The image enhancing system as claimed in claim 2, wherein the second resolution low-pass filter is a vertical low-pass horizontal low-pass filter.

9. The image enhancing system as claimed in claim 2, wherein the second resolution amplifying unit is an amplifier.

10. The image enhancing system as claimed in claim 2, wherein the second resolution amplifying unit is y transfer function.

11. The image enhancing system as claimed in claim 2, wherein the frequency of the second resolution high-pass filter and the second resolution low-pass filter is set depending on the specification of the image.

12. The image enhancing system as claimed in claim 1, wherein the first resolution high-pass filter comprises one filter or more than one filter.

13. The image enhancing system as claimed in claim 1, wherein the number of the first resolution thresholds is the same as the first resolution high-pass filters.

14. The image enhancing system as claimed in claim 1, wherein the number of the first resolution amplifying units is the same as the first resolution high-pass filters.

15. The image enhancing system as claimed in claim 1, wherein the first resolution high-pass filter further comprises a vertical high-pass horizontal high-pass filter, a vertical high-pass horizontal low-pass filter and a vertical low-pass horizontal high-pass filter.

16. The image enhancing system as claimed in claim 1, wherein the first resolution low-pass filter is a vertical low-pass horizontal low-pass filter.

17. The image enhancing system as claimed in claim 1, wherein the first resolution amplifying unit is an amplifier.

18. The image enhancing system as claimed in claim 1, wherein the first resolution amplifying unit is y transfer function.

19. The image enhancing system as claimed in claim 1, wherein the frequency of the first resolution high-pass filter and the first resolution low-pass filter is set depending on the specification of the image.
